(19) United States
(12) Patent Application Publication
(10) Pub. No.: US 2016/0054758 A1
(43) Pub. Date: Feb. 25, 2016

(54) DISPLAY DEVICE

(71) Applicant: SAMSUNG DISPLAY CO., LTD., Yongin-City (KR)

(72) Inventor: Jeong Won Han, Seongnam-si (KR)

(21) Appl. No.: 14/629,430

(22) Filed: Feb. 23, 2015

(30) Foreign Application Priority Data
Aug. 19, 2014 (KR) 10-2014-0107713

(51) Int. Cl. G06F 1/16

(52) U.S. Cl. CPC G06F 1/1652

(57) ABSTRACT

A display device includes: a flexible display panel; an accommodation unit in which the flexible display panel is accommodated; and a bending adjuster located on one surface of the flexible display panel and configured to adjust curvature of the flexible display panel.

### CROSS-REFERENCE TO RELATED APPLICATION

This application claims priority to and the benefit of Korean Patent Application No. 10-2014-0107713, filed on Aug. 19, 2014, with the Korean Intellectual Property Office, the entire disclosure of which is incorporated by reference herein.

### BACKGROUND

1. Field

Aspects of embodiments of the present invention relate to a display device.

2. Description of the Related Art

A display device is an apparatus for displaying an image and, recently, flexible display devices have been further developed.

A conventional flexible display device refers to an apparatus including a flexible display panel for displaying an image. The flexible display device may be folded or rolled around a roll so that the total size thereof may be reduced.

With the recent trend of the display devices having a larger screen, a difference in the viewing angle may become disadvantageously increased between looking at the center portion of the screen and looking at the left and right end portions thereof. In other words, when a user looks at an image displayed on the screen from a position corresponding to a center portion of the large TV, the user may clearly recognize the image displayed at the center portion of the screen. However, when the user looks from the center point to the left or right side of the screen, the image may seem blurry or faint or the screen may not be clear due to ambient light reflection off the screen. This drawback of the viewing angle difference may be improved by concavely bending the screen.

Therefore, there is a desire for a display device including a large screen designed to reduce an accommodation area and also improve the viewing angle difference.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Embodiments of the present invention are directed to a display device including a flexible display panel capable of adjusting curvature when being spread out.

According to an embodiment of the present invention, a display device includes: a flexible display panel; an accommodation unit in which the flexible display panel is rolled up and accommodated; and a bending adjuster located on one surface of the flexible display panel and configured to adjust curvature of the flexible display panel.

The flexible display panel may be bent to have a curvature.

The bending adjuster may adjust the curvature of the display panel in a length direction.

The bending adjuster may have a curvature in a width direction.

The bending adjuster may include at least one curvature adjustment portion.

The curvature of the bending adjuster may be adjusted at the curvature adjustment portion.

The bending adjuster may be made of a flexible material.

The flexible display panel may be a rollable display substrate.

The accommodation unit may include a driver configured to drive the flexible display panel and a first housing having a cylinder form and the first housing containing the driver may be rotatable to roll the flexible display panel around an external surface thereof.

The first housing may have a first slot and the driver and the flexible display panel may be connected to each other through the first slot.

The accommodation unit may further include a second housing containing the first housing and having a space for accommodating the flexible display panel rolled around the external surface of the first housing.

The second housing may have a second slot and the flexible display panel may be drawable from the accommodation unit through the second slot.

The display device may further include a case in which the accommodation unit is located.

The case may have an opening through which the flexible display panel is drawable in one direction.

The display device may further include a stopper located on one end portion of the flexible display panel.

The stopper may have a larger size than the opening.

According to embodiments of the present invention, a display device is capable of adjusting a screen size of a flexible display panel, reducing a size of the display device, easily changing curvature of the flexible display panel, and improving viewing angle difference.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a schematic perspective view illustrating a spread flexible display panel in a display device according to one embodiment of the present invention;

FIG. 2 is a schematic perspective view illustrating the rolled flexible display panel in the display device according to one embodiment of the present invention;

FIG. 3 is a cross-sectional view taken along a line A-A′ of FIG. 1;

FIG. 4 is a cross-sectional view taken along a line B-B′ of FIG. 2;

FIG. 5 is a schematic front view illustrating a spread flexible display panel in the display device according to one embodiment of the present invention;

FIG. 6 is a schematic perspective view illustrating a flexible display panel having curvature of the display device according to one embodiment of the present invention;

FIG. 7 is a cross-sectional view taken along a line C-C′ of FIG. 6;

FIG. 8 is a schematic front view illustrating the flexible display panel having curvature of the display device according to one embodiment of the present invention;

FIGS. 9A and 9B are views illustrating a flexible display panel of which curvature is adjusted in one step;

FIGS. 10A to 10D are views illustrating a flexible display panel of which curvature is adjusted in three steps;

FIG. 11 is an enlarged plan view illustrating part A of FIG. 1;

FIG. 12 is a cross-sectional view taken along a line D-D′ of FIG. 11;

FIG. 13 is a schematic perspective view illustrating a spread flexible display panel in a display device according to another embodiment of the present invention;

FIG. 14 is a schematic perspective view illustrating a flexible display panel having curvature of the display device according to another embodiment of the present invention;

FIG. 15 is a schematic perspective view illustrating a spread flexible display panel in a display device according to yet another embodiment of the present invention; and

FIG. 16 is a schematic perspective view illustrating a flexible display panel having curvature of the display device according to yet another embodiment of the present invention.

### DETAILED DESCRIPTION

Advantages and features of the present invention and methods for achieving them will be made clear from embodiments described below in detail with reference to the accompanying drawings. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. The present invention is merely defined by the scope of the claims. Therefore, well-known constituent elements, operations and techniques are not described in detail in the embodiments in order to prevent the present invention from being obscurely interpreted. Like reference numerals refer to like elements throughout the specification.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

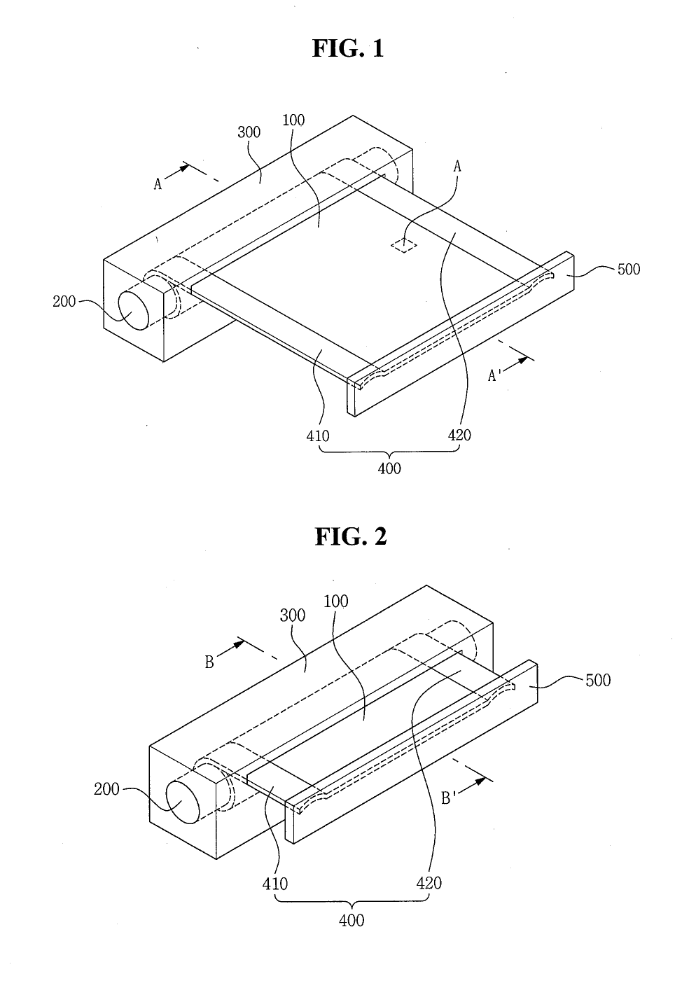

Hereinafter, a display device according to one embodiment of the present invention will be described with reference to FIGS. 1 to 8.

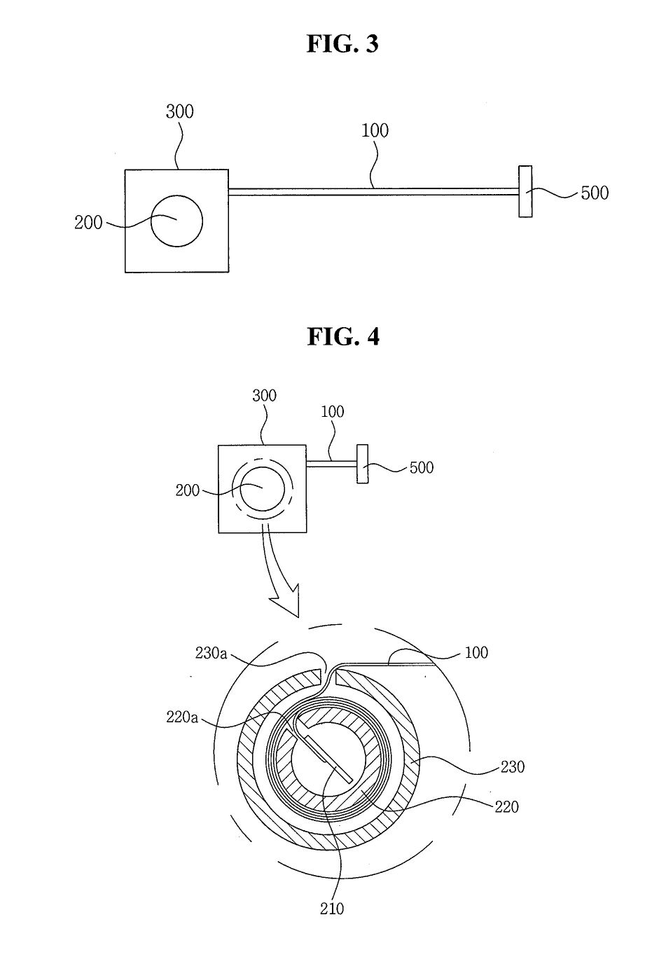

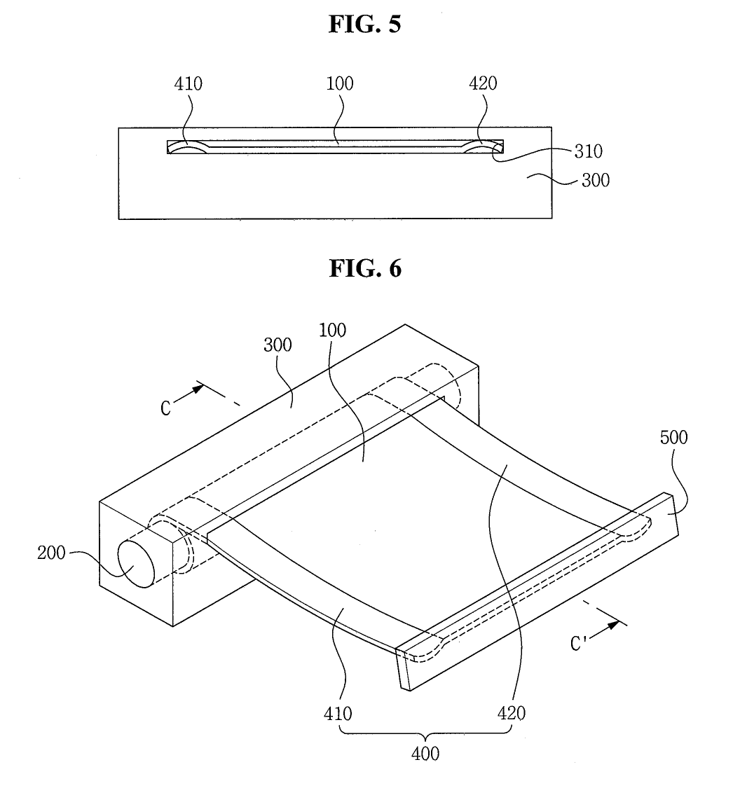

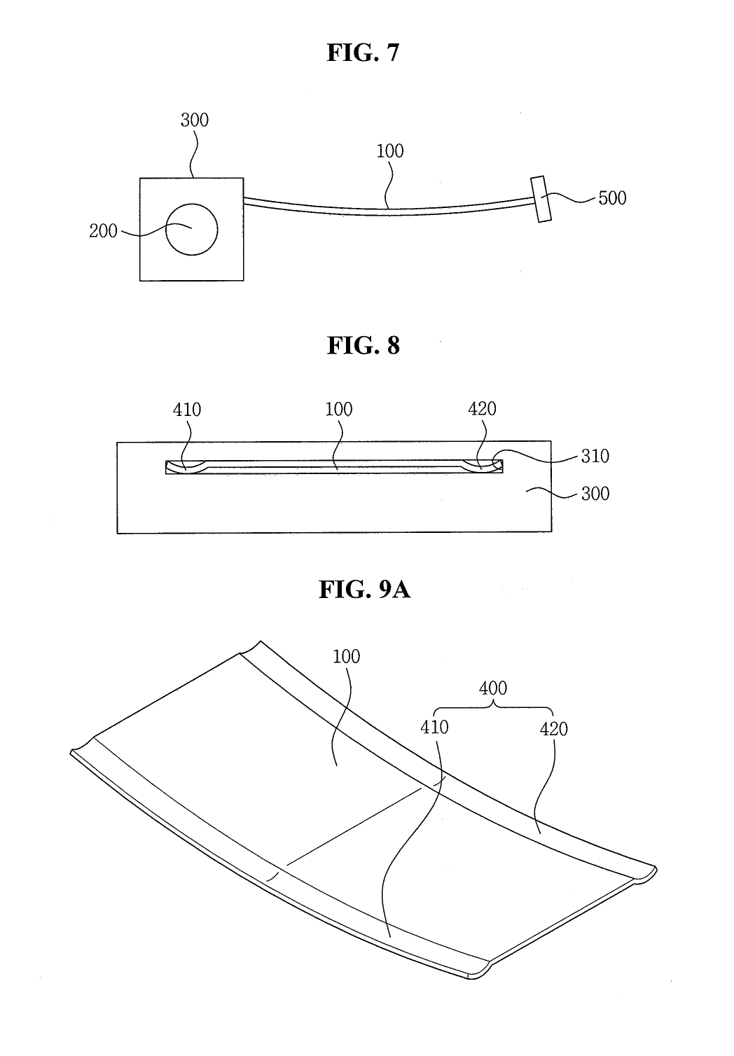

FIG. 1 is a schematic perspective view illustrating a spread flexible display panel in a display device according to one embodiment of the present invention. FIG. 2 is a schematic perspective view illustrating the rolled flexible display panel in the display device according to one embodiment of the present invention. FIG. 3 is a cross-sectional view taken along a line A-A′ of FIG. 1. FIG. 4 is a cross-sectional view taken along a line B-B′ of FIG. 2. FIG. 5 is a schematic front view illustrating a spread flexible display panel in the display device according to one embodiment of the present invention. FIG. 6 is a schematic perspective view illustrating a flexible display panel having curvature of the display device according to one embodiment of the present invention. FIG. 7 is a cross-sectional view taken along a line C-C′ of FIG. 6. FIG. 8 is a schematic front view illustrating the flexible display panel having curvature of the display device according to one embodiment of the present invention.

Herein, a scroll form which may be rolled around a roll is described as one embodiment of the present invention, but embodiments of the present invention are not limited thereto. Thus, the display device may have many different forms so that the flexible display panel can be folded or rolled up.

Generally, an accommodation mode refers to a case where a flexible display panel 100 is accommodated by being rolled up and a spread mode refers to a case where the flexible display panel 100 is spread out and is capable of displaying an image to be viewed.

Referring to FIGS. 1 to 5, the display device according to one embodiment of the present invention may include a flexible display panel 100, an accommodation unit 200, a case 300, a bending adjuster 400, and a stopper 500.

The flexible display panel 100 may display an image processed in the display device. For example, if the display panel is a mobile terminal (e.g., mobile phones), images such as user interface (UI) or graphic user interface (GUI) may be displayed. The flexible display panel 100 may include a flexible substrate or film oriented to face each other with a liquid crystal or an organic light emitting diode (OLED) interposed therebetween.

The flexible display panel 100 may be provided in a transparent type or a transmissive type. On a top surface of the flexible display panel 100, one of a touch film including a touch sensor which may detect a touch movement, a touch sheet, and a touch pad may be provided. The flexible display panel 100 may be connected to a controller and display an image in response to a signal transmitted from the controller.

The flexible display panel 100 may be flexible and may be extendable from the case 300. The flexible display panel 100 may be rolled up to be accommodated in the accommodation unit 200 (FIG. 2) or drawn out from the accommodation unit 200 (FIG. 1). The flexible display panel 100 may be extendable from the case 300 by the accommodation unit 200 so that a display area may be variably exposed to the outside.

The accommodation unit 200 may be located inside the case 300, and support one end portion of the flexible display panel 100. The accommodation unit 200 may include a driver 210, a first housing 220, and a second housing 230.

The first housing 200 may include the driver 210 equipped therein and a first slot 220a for inserting the flexible display panel 100 thereto. The flexible display panel 100 may be drawn out from the first housing 200 and may be rolled around an outer surface of the first housing 220. In one embodiment, the first housing 220 is provided in a cylinder form that is rotatable. The first housing 200 may be rotated manually or by motor power in order to roll or spread the flexible display panel 100.

In one embodiment, the flexible display panel 100 may be pre-stressed. Accordingly, if an external force is not applied on the flexible display panel 100, the flexible display panel 100 remains rolled up. When an external force is exerted on the flexible display panel 100, the flexible display panel 100 may be spread out. Further, when the external force is removed, the flexible display panel 100 may be rolled back into the first housing 200.

The second housing 230 may have a space for accommodating the first housing 220 and the flexible display panel 100 rolled around the external surface of the first housing 220. The second housing 230 may include a second slot 220a for drawing the flexible display panel 100 accommodated therein to the outside.

In other words, one end portion of the flexible display panel 100 may be connected to the driver 210. The flexible display panel 100 may pass through the first slot 220a of the first housing 220. Further, the flexible display panel 100 may be rolled around the external surface of the first housing 220 or drawn out through the second slot 230a. The other end of the flexible display panel 100 may have a thickness larger than the width of the second slot 230a. Accordingly, the other end of the display panel 100 may be stuck in the external surface of the second housing 230.

The case 300 may support one end portion of the flexible display panel 100. Further, the case 300 may play a role in the flexible display panel 100 being spread out therefrom and rolled up therein so that the display area of the flexible display panel 100 may be variably exposed. The case 300 may include the accommodation unit 200 therein which the flexible display panel 100 is rolled around. The case 300 may have an opening 310 through which the flexible display panel 100 is extendable.

The stopper 500 may be located on one end portion of the flexible display panel 100 so that the flexible display panel 100 may not be completely rolled up into the case 300. The stopper 500 may be larger than a size of the opening 310 of the case 300 so that it does not fit through the opening.

The above-described structure may allow a mode conversion of the display device between the accommodation mode and the spread mode. Further, the display device may be reduced in size.

In one embodiment, when the flexible display panel 100 is spread out, the flexible display panel 100 may be substantially planar as illustrated in FIGS. 1 and 3. For larger planar flexible display panels, a viewing angle difference may occur. Although being formed to have a curvature so as to reduce the viewing angle difference, the flexible display panel 100 may not keep the curvature due to a restitution force alone. Further, if an additional element like a hinge is provided on the flexible display panel 100 in order to change the curvature, the manufacturing cost may increase.

Therefore, the display device according to one embodiment of the present invention may include a bending adjuster 400.

Referring to FIGS. 1 to 8, the bending adjuster 400 may be located on one surface of the flexible display panel 100 and adjust the curvature of the flexible display panel 100. In some embodiments, the bending adjuster 400 may change the curvature in a length direction. The bending adjuster 400 may have a curvature in a width direction. The bending adjuster 400 may be manually transformed and may include a first bending adjustment bar 410 and a second bending adjustment bar 420.

In one embodiment, a flat mode refers to a case where the flexible display panel 100 is spread out and is substantially planar. Further, a curved mode refers to a case where the flexible display panel 100 is spread out and is curved. The flexible display panel 100 having a curved form means the flexible display panel 100 is bent to have a curvature.

When the flexible display panel 100 is in the flat mode, the bending adjuster 400 may have a curvature in a width direction and a concave part may face upwards from the flexible display panel 100 (FIG. 5).

When the flexible display panel 100 is in the curved mode, the bending adjuster 400 has a curvature in a width direction and a concave part may face downwards from the flexible display panel 100 (FIG. 8).

In more detail, in the flat mode, the bending adjuster 400 may support the flexible display panel 100 to keep the plane form (FIG. 1). In the curved mode, the bending adjuster 400 may be bent to have a curvature caused by pressure applied by a user. As the bending adjuster 400 is bent, the flexible display panel 100 may be bent to have the same curvature as the bending adjuster 400 (FIG. 6).

Since provided in a U-shape, the bending adjuster 400 may keep the state of being spread out or bent. In other words, when bent with a curvature, a U-shaped cross-section of the bending adjuster 400 may play a role in maintaining the curvature thereof.

The bending adjuster 400 may be formed of a polymer material or a metal material. For example, the bending adjuster 400 may be made of one selected from a group of kapton, polyethersulphone (PES), polycarbonate (PC), polyimide (PI), polyethyleneterephthalate (PET), polyethylenenaphthalate (PEN), polyacrylate (PAR), and fiber reinforced plastic (FRP).

A user may easily adjust the flexible display panel 100 to have a desired curvature using the bending adjuster 400. Therefore, the user may improve the viewing angle difference of the display device in accordance with a corresponding use environment. For example, if a user group is small and the viewing angle of the user is narrow, the curvature of the flexible display panel 100 may be adjusted to be small. In contrary, if a user group is large and the viewing angle of the user is wide, the curvature of the flexible display panel 100 may be adjusted to be large. Further, the bending adjuster 400 may simply adjust the curvature of the flexible display panel 100 without an additional element such as a hinge, thereby reducing a manufacturing cost.

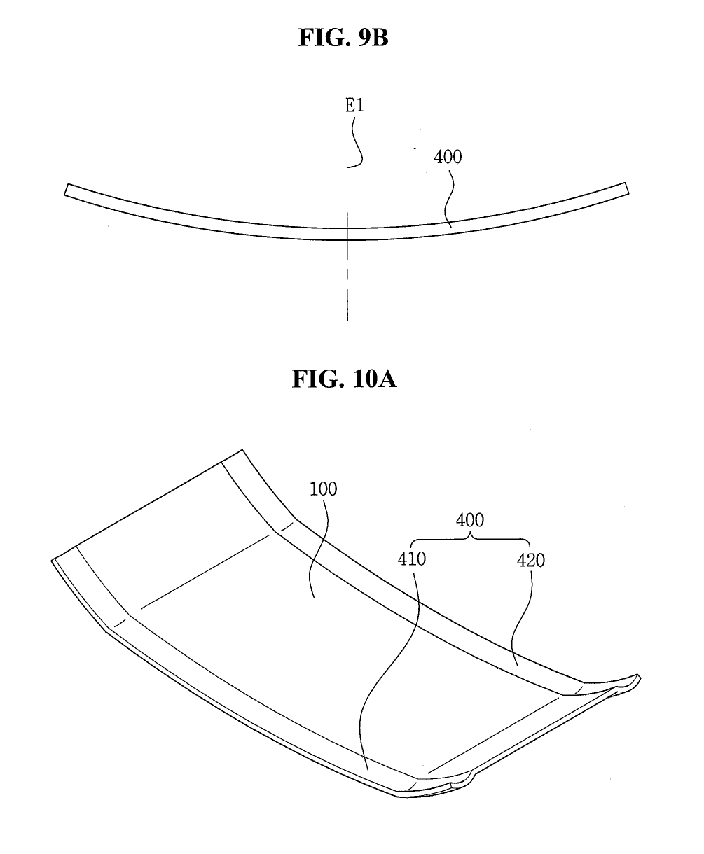

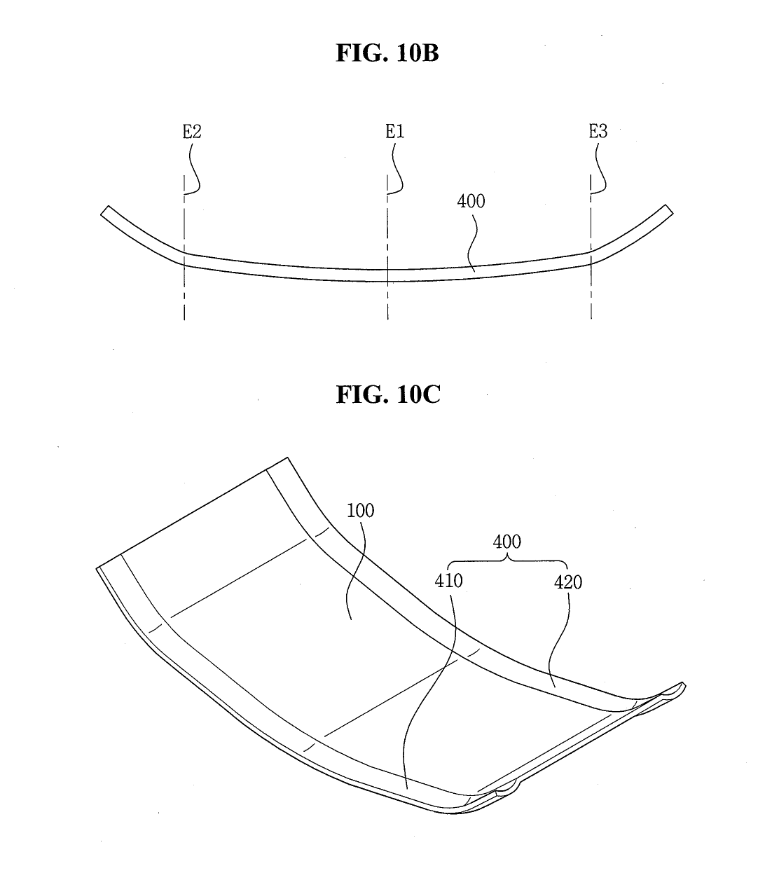

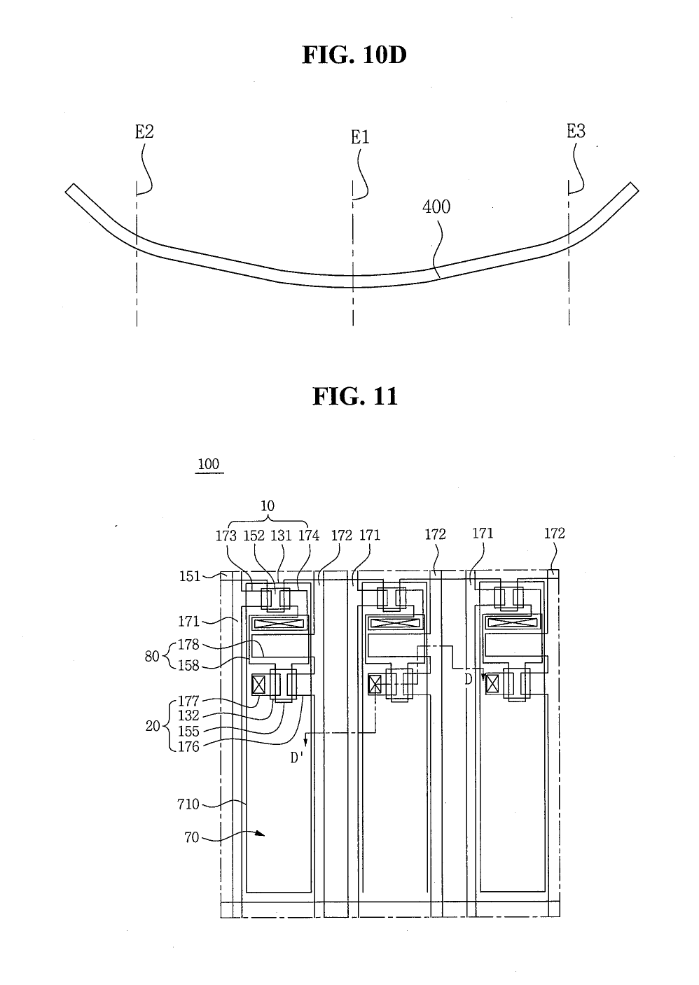

Hereinafter, the bending adjuster 400 that is adjustable in multiple steps will be described with reference to FIGS. 9A to 10D.

FIGS. 9A and 9B are views illustrating a flexible display panel of which curvature is adjusted in one step. FIGS. 10A to 10D are views illustrating a flexible display panel of which curvature is adjusted in three steps.

Referring to FIGS. 9A to 10D, the bending adjuster 400 may include at least one curvature adjustment portion E1, E2, and E3. The curvature of the bending adjuster 400 may be adjusted at the curvature adjustment portions E1, E2, and E3. For example, when a user exerts pressure on the curvature adjustment portions E1, E2, an E3, the curvature of the bending adjuster 400 may be adjusted with respect to the curvature adjustment portions E1, E2, and E3.

In more detail, referring to FIGS. 9A and 9B, the curvature adjustment portion E1 may be located at a center portion of the bending adjuster 400. The bending adjuster 400 may be bent with respect to the curvature adjustment portion E1. In other words, the bending adjuster 400 may be adjusted in one step with respect to the curvature adjustment portion E1 and adjust the curvature of the flexible display panel 100. When adjusted in one step, the flexible display panel 100 may have a single curvature.

Referring to FIGS. 10A to 10D, the bending adjuster 400 may be bent with respect to three curvature adjustment portions E1, E2, and E3. For example, the bending adjuster 400 may be adjusted in three steps with respect to the curvature adjustment portions E1, E2, and E3 to adjust the curvature of the flexible display panel 100. When adjusted in three steps, the flexible display panel 100 may have three curvatures. In some embodiments, for example, the curvature of the flexible display panel 100 may be adjusted only with respect to the curvature adjustment portion E1 at the center portion. In some embodiments, the curvature thereof may be adjusted with respect to the curvature adjustment portions E2 and E3 at right and left sides. In some embodiments, the curvature thereof may be adjusted with respect to all three curvature adjustment portions E1, E2 and E3.

In some embodiments, the flexible display panel 100 may be adjusted in multiple steps of four or more and the number of the variable curvature adjustment portions E1, E2, and E3 may vary. In one embodiment, the curvature adjustment portion E1, E2, and E3 of the bending adjuster 400 may have an incision portion for an easier adjustment.

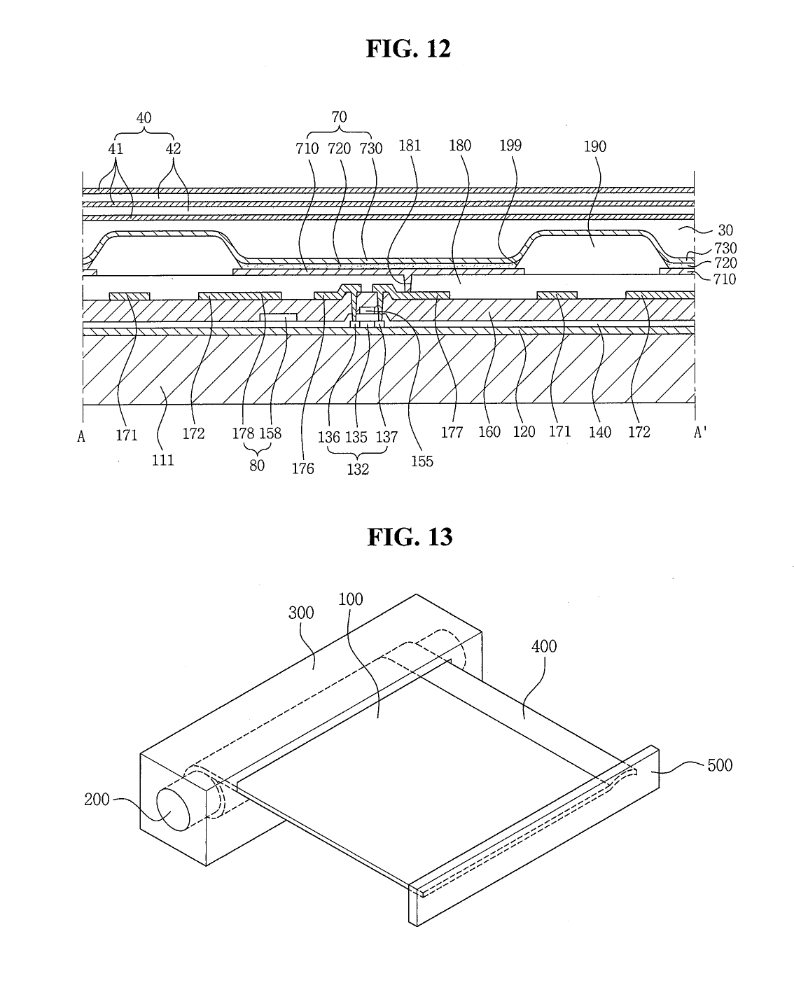

Hereinafter, one pixel of the flexible display panel 100 will be described in detail with reference to FIGS. 11 and 12. Herein, it is assumed that the organic light emitting display device is used as one embodiment of the present invention.

FIG. 11 is an enlarged plan view illustrating an A part of FIG. 1. FIG. 12 is a cross-sectional view taken along a line D-D′ of FIG. 11.

Although FIGS. 11 and 12 illustrate an active-matrix (AM)-type organic light emitting display device having a 2Tr-1 Cap structure, which includes two thin film transistors (TFTs) 10 and 20 and a capacitor 80 in each pixel of the display area, but embodiments of the present invention are not limited thereto.

In some embodiments, the organic light emitting display device according to one embodiment of the present invention may have many different structures including three or more TFTs and two or more capacitors in one pixel, and may further include additional lines. Herein, the term “pixel” refers to the smallest unit for displaying an image, and the display area displays an image using a plurality of pixels.

The flexible display panel 100 according to one embodiment of the present invention may include a first substrate 111 and a plurality of pixels defined on the first substrate 111. Each of the plurality of pixels may include the switching TFT 10, the driving TFT 20, the capacitor 80, and the OLED 70. In addition, the first substrate 111 may include a gate line 151 arranged along one direction and data and common lines 171 and 172 insulated from and intersecting the gate line 151.

Herein, each pixel may be defined by the gate, data, and common lines 151, 171, and 172, but is not limited thereto.

The OLED 70 may include a first electrode 710, an organic light emitting layer 720 formed on the first electrode 710, and a second electrode 730 formed on the organic light emitting layer 720. Herein, one or more first electrodes 710 may be formed on each pixel, and thus the first substrate 111 may include the plurality of first electrodes 710 spaced from each other.

In one embodiment, the first electrode 710 may be a positive end portion (anode) serving as a hole injection electrode and the second electrode 730 may be a negative end portion (cathode) serving as an electron injection electrode. However, embodiments of the present invention are not limited thereto, and thus the first electrode 710 may function as a cathode, and the second electrode 730 may function as an anode according to a method of driving the organic light emitting display device. Further, the first electrode 710 may be a pixel electrode and the second electrode 730 may be a common electrode.

In the OLED, a hole and an electron injected to the organic light emitting layer 720 are combined with each other to form an exciton, and the OLED emits light by energy generated when the exciton falls from an excited state to a ground state.

The capacitor 80 may include a pair of storage electrodes 158 and 178 with an interlayer insulating layer 160 interposed therebetween. In one embodiment, the interlayer insulating layer 160 may be a dielectric material. Capacitance of the capacitor 80 may be determined by electric charges stored in the capacitor 80 and voltage across the pair of storage electrodes 158 and 178.

The switching TFT 10 may include a switching semiconductor layer 131 and switching gate, source, and drain electrodes 152, 173, and 174. The driving TFT 20 may include a driving semiconductor layer 132 and driving gate, source, and drain electrodes 155, 176, and 177.

The switching TFT 10 may function as a switching device which selects a pixel to perform light emission. The switching gate electrode 152 may be connected to the gate line 151 and the switching source electrode 173 may be connected to the data line 171. The switching drain electrode 174 may be spaced from the switching source electrode 173 and may be connected to the first storage electrode 158.

The driving TFT 20 may apply a driving power to the first electrode 710, which allows the organic light emitting layer 720 of the OLED 70 in a selected pixel to emit light. The driving gate electrode 155 may be connected to the first storage electrode 158 that is connected to the switching drain electrode 174. The driving source electrode 176 and the second storage electrode 178 may be respectively connected to the common power line 172.

The driving drain electrode 177 may be connected to the first electrode 710 of the OLED 70 through a drain contact hole 181.

With the above-described structure, the switching TFT 10 may be operated by a gate voltage applied to the gate line 151, and may function to transmit a data voltage applied to the data line 171 to the driving TFT 20.

Voltage equivalent to a difference between a common voltage applied from the common power line 172 to the driving TFT 20 and the data voltage transmitted from the switching TFT 10 may be stored in the capacitor 80, and current corresponding to the voltage stored in the capacitor 80 may flow to the OLED 70 via the driving TFT 20, so that the OLED 70 may emit light.

Configurations of the flexible display panel 100 according to one embodiment will be described in more detail.

The OLED 70, the driving TFT 20, the capacitor 80, the data line 171, and the common power line 172 illustrated in FIG. 12 will be primarily described. Further, the switching semiconductor layer 131 and the switching gate, source and drain electrodes 152, 173, and 174 of the switching TFT 10 may have the same laminated structure as the driving semiconductor layer 132 and the driving gate, source and drain electrodes 155, 176, and 177 of the driving TFT 20, and thus the repeated description will not be provided.

According to one embodiment of the present invention, the first substrate 111 may be made of a flexible material, such as plastics. In more detail, the flexible substrate 310 may include at least one selected from a group consisting of a kapton, a polyethersulphone (PES), a polycarbonate (PC), a polyimide (PI), a polyethyleneterephthalate (PET), a polyethylenenaphthalate (PEN), a polyacrylate (PAR), and a fiber reinforced plastic (FRP). In particular, the polyimide may exhibit high thermal resistivity, useful when the flexible substrate 310 is subject to high-temperature processes.

Further, the first substrate 111 may have a thickness of from about 5 μm to about 200 μm. If a thickness is less than 5 μm, for example, the first substrate 111 might not stably support the OLED 70. Alternatively, when the first substrate 111 has a thickness more than 200 μm, for example, flexibility may be reduced. The first substrate 111 may have a coefficient of thermal expansion (CTE) of from about 3 ppm/° C. to about 10 ppm/° C.

A buffer layer 120 may be located on the first substrate 111. The buffer layer 120 may reduce or prevent infiltration of undesirable elements and planarize a surface, and may include various materials in accordance therewith. For instance, the buffer layer 120 may be made of at least one selected from a group of silicon nitrides (SiNx), silicon oxides (SiO2), and silicon oxynitrides (SiOxNy). However, the buffer layer 120 may not be always necessary and may be omitted according to the kind of the first substrate 111 and process conditions thereof.

The driving semiconductor layer 132 may be located on the buffer layer 120. The driving semiconductor layer 132 may include at least one semiconductor material selected from a group of polycrystalline silicon, amorphous silicon, and oxide semiconductors. Further, the driving semiconductor layer 132 may have a channel region 135 that is not doped with impurities and p+ doped source and drain regions 136 and 137 that are formed on both sides of the channel region 135. In this case, p-type impurities, such as boron B, may be used as dopant ions and B2H6 may be generally used. Such impurities may vary depending on the kinds of the TFTs.

A gate insulating layer 140 made of a silicon nitride or a silicon oxide is located on the driving semiconductor layer 132. The gate insulating layer 140 may include at least one of tetraethylorthosilicate (TEOS), silicon nitrides (SiNx), and silicon oxides (SiO2). For example, the gate insulating layer 140 may have a double-layer structure where a SiNx layer having a thickness of 40 nm and a TEOS layer having a thickness of 80 nm are sequentially laminated. However, the gate insulating layer 140 according to the one embodiment of the present invention is not limited thereto.

The driving gate electrode 155, the gate line (reference number 151 of FIG. 1), and the first storage electrode 158 may be formed on the gate insulating layer 140. In this case, the driving gate electrode 155 may be located to overlap at least a part of the driving semiconductor layer 132, that is, in more detail, the channel region 135. The driving gate electrode 155 may prevent the channel region 135 from being doped with impurities when the drain and source regions 136 and 137 of the driving semiconductor layer 132 are doped with the impurities in the process of forming the driving semiconductor layer 132.

The gate electrode 155 and the first storage electrode 158 may be located on the same layer, and may be made of substantially the same metal material. In this case, the metal material may include at least one selected from a group of molybdenum (Mo), chromium (Cr), and tungsten (W). For example, the gate electrode 155 and the first storage electrode 158 may be made of molybdenum (Mo) or molybdenum alloys.

An insulating layer 160 configured to cover the driving gate electrode 155 may be located on the gate insulating layer 140. The insulating layer 160 may be an interlayer insulating layer. The insulating layer 160 may be made of a silicon nitride (SiNx) or a silicon oxide (SiOx) as the gate insulating layer 140. The gate insulating layer 140 and the insulating layer 160 have a contact hole to expose the source and drain regions of the driving semiconductor layer 132,

The driving source electrode 176, the driving drain electrode 177, the data line 171, the common power line 172, the second storage electrode 178 may be located on the insulating layer 160 of the display area DA. The driving source and drain electrodes 176 and 177 may be respectively connected to the source and drain regions of the driving semiconductor layer 132 through the contact hole.

In more detail, the driving source electrode 176, the driving drain electrode 177, the data line 171, the common power line 172, and the second storage electrode 178 may be formed of refractory metal including at least one selected from a group of molybdenum, chromium, tantalum, and titanium or metal alloys thereof and may have a multi-layer structure including a refractory metal film and a low-resistance conductive film. Examples of the multi-layer structure include: a double-layer structure including a chromium or molybdenum (alloy) lower film and an aluminum (alloy) upper film; and a triple-layer structure including a molybdenum (alloy) lower film, an aluminum (alloy) intermediate film, and a molybdenum (alloy) upper film.

The driving source electrode 176, the driving drain electrode 177, the data line 171, the common power line 172, and the second storage electrode 178 may be formed of various conductive materials other than the above-described materials.

Accordingly, the driving thin film transistor 20 may be formed including the driving semiconductor layer 132, the driving gate electrode 155, the driving source electrode 176, and the driving drain electrode 177. However, the configurations of the driving thin film transistor 20 are not limited thereto, and thus may be modified to have many different structures.

A protective layer 180 may be located on the insulating layer 160 to cover the driving source electrode 176, the driving drain electrode 177, and the like. The protective layer 180 may be made of organic materials, such as polyacrylates and polyimides. The protective layer 180 may be a planarizing layer.

The protective layer 180 may be formed of at least one selected from a group of polyacrylate resins, epoxy resins, phenolic resins, polyamide resins, polyimide reins, unsaturated polyester resins, poly-phenylenether resins, poly-phenylenesulfide resins, and benzocyclobutene (BCB).

The protective layer 180 may have the drain contact hole 181 to expose the driving drain electrode 177.

The first electrode 710 may be formed on the protective layer 180 and connected to the driving drain electrode 177 through the drain contact hole 181 of the protective layer 180.

A pixel defining layer 190 may be formed on the protective layer 180 and cover the first electrode 710. The pixel defining layer 190 may have an opening 199 to expose the first electrode 710.

In other words, the first electrode 710 may correspond to the opening 199 of the pixel defining layer 190. The pixel defining layer 190 may be made of resins, such as polyacrylate resins and polyimide resins.

Further, the pixel defining layer 190 may be made of a photosensitive organic material or a photosensitive polymer material. For example, the pixel defining layer 190 may be made of one of polyacrylates, polyimides, photo sensitive polyimides (PSPI), photosensitive acryl (PA), and photosensitive novolak resins.

The organic light emitting layer 720 may be formed on the first electrode 710 in the opening 199 of the pixel defining layer 190 and the second electrode 730 may be formed on the pixel defining layer 190 and the organic light emitting layer 720.

Accordingly, the OLED 70 may be formed including the first electrode 710, the organic light emitting layer 720, and the second electrode 730.

One of the first and second electrodes 710 and 730 may be formed of a transparent conductive material and the other one thereof may be formed of a transflective or reflective conductive material. Depending on the material forming the first and second electrodes 710 and 730, the organic light emitting display device may become a top-emission type, a bottom-emission type, or a both-side-emission type.

For example, when the organic light emitting display device is provided in the top-emission type, the first electrode 710 may be formed of the transflective or reflective conductive material and the second electrode 730 may be formed of the transparent conductive material.

At least one selected from a group of indium tin oxides (ITO), indium zinc oxides (IZO), zinc oxides (ZnO), and indium oxides (In2O3) may be used as the transparent conductive material. At least one selected from a group of lithium (Li), calcium (Ca), lithium fluoride/calcium (LiF/Ca), lithium fluoride/aluminum (LiF/Al), aluminum (Al), silver (Ag), magnesium (Mg), or gold (Au) may be used as the reflective material.

The organic light emitting layer 720 may be made of low molecular weight organic materials or high molecular weight organic materials. The organic light emitting layer 720 may have a multi-layer structure including a light emitting layer and at least one of a hole injection layer (HI), a hole transporting layer (HTL), an electron transporting layer (ETL) and an electron injection layer (EIL). For example, the HIL may be located on the first electrode 710 that is a positive end portion and the HTL, light emitting layer, ETL, and EIL may be sequentially laminated thereon.

According to one embodiment of the present invention, the organic light emitting layer 720 is formed only inside the opening 199 of the pixel defining layer 190, but embodiments of the present invention are not limited thereto. Therefore, at least one layer of the organic light emitting layer 720 may not only be located on the first electrode 710 inside the opening 199 of the pixel defining layer 190 but also be located between the pixel defining layer 190 and the second electrode 730. In more detail, HIL, HTL, ETL, EIL, and the like of the organic light emitting layer 720 may be formed on an area rather than the opening 199 by an open mask, and the light emitting layer of the organic light emitting layer 720 may be formed on each opening 199 by a fine metal mask (FMM).

In one embodiment, when the LCD display is used as one embodiment of the present invention, the first electrode 710 may be physically and electrically connected to the driving drain electrode 177 through the drain contact hole 181 and applied with a data voltage from the driving drain electrode 177. The first electrode 710 applied with the data voltage may form an electric field with the second electrode (common electrode) applied with a common voltage, which determines a direction of the liquid crystal molecules of the liquid crystal layer between the two electrodes. The first electrode 710 and the second electrode form a capacitor (hereinafter “a liquid crystal capacitor”), which may maintain an applied voltage although the thin film transistor is turned off.

In one embodiment, a capping layer 30 may be located on the second electrode 730 in order to protect the OLED 70 before a thin film encapsulation layer 40 is formed and to prevent the OLED 70 from being damaged in the forming of the thin film encapsulation layer 40. It will be understood that the capping layer 30 can be omitted and that an organic layer 42 of the thin film encapsulation layer 40 may be located there instead of the capping layer 30.

The capping layer 30 may be made of an ultraviolet (UV)-blocking layer configured to block UV rays that may exert adverse effects on the OLED 70. For example, the UV rays may be radiated so as to form the organic layer 42 in the forming of the thin film encapsulation layer 40. In this case, the capping layer 30 having a UV-blocking property may be formed in order to prevent damages on the OLED 70.

The capping layer 30 may have a single-layer structure but may have a multi-layer structure having two or more layers. The capping layer 30 may also have properties of preventing infiltration of moisture or oxygen.

The thin film encapsulation layer 40 may be formed on the capping layer 30. The thin film encapsulation layer 40 may be directly formed on the OLED 70 and encapsulate the driving circuit and the OLED.

The thin film encapsulation layer 40 may have a structure including two or more inorganic layers 41 and two or more organic layers 42. The inorganic layer 41 and the organic layer 42 are alternately laminated. FIG. 10 illustrates that three inorganic layers 41 and two organic layers 42 are alternately laminated to form the thin film encapsulation layer 40, but the number of the inorganic layers 41 and the organic layers 42 is not limited thereto.

The inorganic layer 41 may include at least one of aluminum oxides (Al₂O₃) or silicon oxides (SiO2). The organic layer 42 may include at least one of epoxies, acrylates, and urethane acrylates. The inorganic layer 41 is configured to prevent infiltration of moisture and oxygen into the flexible display panel and the organic layer 42 is configured to reduce internal stress of the inorganic layer 41 or filling micro-cracks and pinholes of the inorganic layer 41.

A touch screen panel may be further located on the thin film encapsulation layer 40. The presence and location of an input touch can be detected by the touch screen panel. For example, a user may use the touch screen panel by using a stylus pen (or a finger of the user) and the like. The touch screen panel may be made of a transparent material.

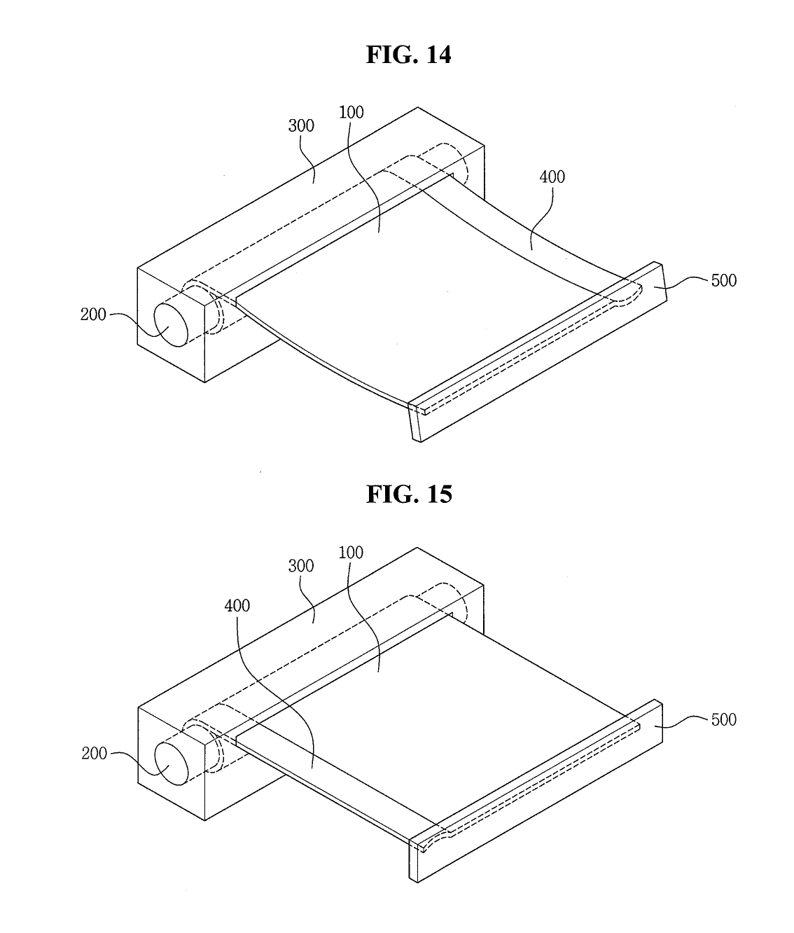

Hereinafter, a display device according to another embodiment of the present invention will be described with reference to FIGS. 13 and 14.

FIG. 13 is a schematic perspective view illustrating a spread flexible display panel in a display device according to another embodiment of the present invention. FIG. 14 is a schematic perspective view illustrating a flexible display panel having curvature of the display device according to another embodiment of the present invention.

Referring to FIGS. 13 and 14, in the bending adjuster 400, the first bending adjustment bar 410 (FIG. 1) may be omitted and only the second bending adjustment bar 420 may be present. In consideration of flexibility and restitution force of the flexible display panel 100, the bending adjuster 400 may include only the second bending adjustment bar 420.

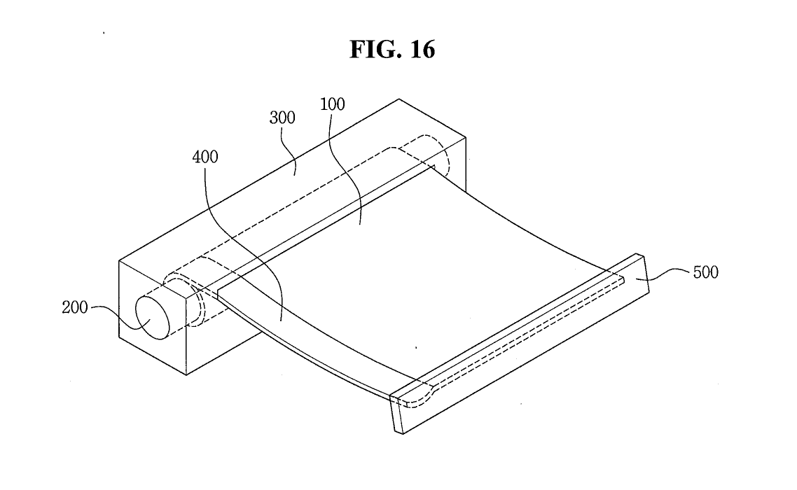

Hereinafter, a display device according to yet another embodiment of the present invention will be described with reference to FIGS. 15 and 16.

FIG. 15 is a schematic perspective view illustrating a spread flexible display panel in a display device according to yet another embodiment of the present invention. FIG. 16 is a schematic perspective view illustrating a flexible display panel having curvature of the display device according to yet another embodiment of the present invention.

Referring to FIGS. 15 and 16, in the bending adjuster 400, the second bending adjustment bar 420 (FIG. 1) may be omitted and only the first bending adjustment bar 410 may be present. In consideration of the flexibility and restitution force of the flexible display panel 100, the bending adjuster 400 may include only the first bending adjustment bar 410.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings.

What is claimed is:

1. A display device comprising:
a flexible display panel;
an accommodation unit in which the flexible display panel is accommodated; and
a bending adjuster located on one surface of the flexible display panel and configured to adjust curvature of the flexible display panel.

2. The display device of claim 1, wherein the flexible display panel is curvable.

3. The display device of claim 1, wherein the bending adjuster is configured to adjust a curvature of the display panel in a length direction.

4. The display device of claim 1, wherein the bending adjuster has a curvature in a width direction.

5. The display device of claim 1, wherein the bending adjuster comprises at least one curvature adjustment portion.

6. The display device of claim 5, wherein a curvature of the bending adjuster is adjustable at the curvature adjustment portion.

7. The display device of claim 1, wherein the bending adjuster comprises a flexible material.

8. The display device of claim 1, wherein the flexible display panel is a rollable display substrate.

9. The display device of claim 1, wherein the accommodation unit comprises a driver configured to drive the flexible display panel and a first housing being cylindrical,
wherein the first housing containing the driver is rotatable to roll the flexible display panel around an external surface thereof.

10. The display device of claim 9, wherein the first housing has a first slot, and
wherein the driver and the flexible display panel are connected to each other through the first slot.

11. The display device of claim 9, wherein the accommodation unit further comprises a second housing containing the first housing and having a space for accommodating the flexible display panel rolled around the external surface of the first housing.

12. The display device of claim 11, wherein the second housing has a second slot and the flexible display panel is drawable from the accommodation unit through the second slot.

13. The display device of claim 1, further comprising a case in which the accommodation unit is located.

14. The display device of claim 13, wherein the case has an opening through which the flexible display panel.

15. The display device of claim 14, further comprising a stopper located on one end portion of the flexible display panel.

16. The display device of claim 15, wherein the stopper is larger than the opening.
